(19) United States
(12) Patent Application Publication
(10) Pub. No.: US 2007/0130545 A1
(43) Pub. Date: Jun. 7, 2007

(54) Information reproduction apparatus and information reproduction program

(76) Inventors: Arito Mochizuki, Musashino (JP); Takaaki Ishii, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/634,166

(22) Filed: Dec. 6, 2006

(30) Foreign Application Priority Data
Dec. 6, 2005 (JP) 2005-351403

(51) Int. Cl. G06F 17/00

(52) U.S. Cl. 715/837

(57) ABSTRACT

A contents reproduction apparatus classifies contents reproducible by user into a group of reproduction candidates and a group of candidates added to the group of reproduction candidates and displays them, wherein the contents are moved from the added candidate group to the reproduction candidate group on predetermined conditions and an amount (ratio, conditions and the like) of contents to be moved can be adjusted arbitrarily by the user in response to input from an input unit, whereby contents groups selected previously by user and other contents groups are mixed in any ratio at user's choice of contents groups that the user desires to look at and listen to and the user can confirm what contents are mixed before the contents groups are mixed.

### CLAIM OF PRIORITY

The present application claims priority from Japanese application JP 2005-351403 filed on Dec. 6, 2005, the content of which is hereby incorporated by reference into this application.

### BACKGROUND OF THE INVENTION

The present invention relates to an apparatus, method and program of reproducing contents information such as music and picture and more particularly to an information reproduction apparatus, method and program that can collect a plurality of pieces of information suitable for user's taste and reproduce them.

Recently, contents such as music and picture are generally stored in storage media such as hard disk drives (HDD) and semiconductor memories included in household electric appliances or portable electronic apparatuses as data in the MP3 (MPEG (moving picture experts group) audio layer-3) format, MPEG format or the like to be reproduced.

The storage media used therein are inexpensive and have large memory capacity. A large number of contents are being stored in electronic apparatuses such as household electric appliances.

In this manner, since the user can store a large number of contents, it is a matter of importance how the user selects his desired contents.

For example, for music, a portable music player can store thousands of musical compositions, so that the user often designates previously prepared play-list or genre or artist to reproduce the musical compositions corresponding to the designated information successively or at random.

When the musical composition that the user desires to listen to currently is decided clearly, the user selects an album or play-list and conversely when the user desires to listen to any music regardless, the user selects the play-list containing a lot of musical compositions prepared by narrowing musical compositions down relatively abstractly and reproduces the musical compositions in the play-list at random.

However, the play-list prepared by making the abstract narrowing-down operation contains too many musical compositions and accordingly the musical composition desired by the user is not sometimes reproduced easily. Further, since the play-list prepared at user's choice is not changed as long as it is not re-edited by the user, there is a problem that it does not match the user's taste as the user listens to it repeatedly or time elapses.

U.S. Pat. No. 6,941,324 discloses the technique in which retrieval using attribute information such as information related to looking and listening action of the user such as the frequency of reproduction and the date of final reproduction, genre and artist is made to produce the play-list dynamically and update it automatically. In the method disclosed in U.S. Pat. No. 6,941,324, the play-list can be composed of static items, that is, items selected by the user and items obtained dynamically by means of retrieval. For example, the play-list having the combination of an album having the genre of jazz and that the user does not listen to recently as well as albums A and B can be composed. Accordingly, the play-list having albums C and D and 7 albums extracted at random can be composed.

### SUMMARY OF THE INVENTION

In the method disclosed in U.S. Pat. No. 6,941,324 however, what musical composition is extracted at random is not understood until the play-list is composed and there arises a possibility that any musical composition that the user does not desire to listen to is contained therein. Further, there is also a possibility that the user prefers the musical composition that is not extracted. The method disclosed in U.S. Pat. No. 6,941,324 is suitable for the case where conditions for the musical compositions that the user desires to listen to are decided clearly, for example, as music having the genre of rock and composed on and after 2000, although when the user listens to music, such conditions are not often decided clearly. Even when an album group that the user desires to listen to at the minimum is decided, there is a possibility that the user gets tired of listening to the album group as such and accordingly there is a situation that the user desires to listen to the album group mixed with some other album groups. In this case, the conditions for the other album groups that the user desires to mix are not decided clearly, although the other album groups are not album groups selected entirely at random and it is desired that the album groups matches the user's psychological state. The mixture ratio of the album groups selected actively by the user and the album groups other than them is changed variously depending on the user's psychological state.

It is an object of the present invention to solve the above problems by providing an information reproduction apparatus in which contents groups selected previously by user and other contents groups are mixed in any ratio at user's choice of contents groups that the user desires to look at and listen to and the user can confirm what contents are mixed before the contents groups are mixed.

In order to solve the above problems, as shown in FIG. 1, the information reproduction apparatus according to the present invention classifies contents (for example, picture data, musical composition data, static and moving data and URL of web) reproducible by user into a group of reproduction candidates (displayed in a second area, for example) and a group of candidates (displayed in a first area, for example) added to the group of reproduction candidates and displays them, wherein the contents are moved from the added candidate group to the reproduction candidate group on predetermined conditions and an amount (ratio, conditions and the like) of contents to be moved can be adjusted arbitrarily by the user in response to input from an input unit.

(1) An information reproduction apparatus according to the present invention comprises an information storage unit for storing information, an information display unit for displaying information, an input unit for inputting instructions from the outside, an information processing unit for processing information, and an output unit for outputting information reproduced by the information processing unit. The information display unit has first and second areas and displays information stored in the information storage unit as icons. The information processing unit reproduces information of the icons contained in the first area. The icons contained in the first area includes a first icon group having 1 or 2 or more icons and a second icon group having 1 or 2 or more icons. The first icon group includes icons of information selected from information stored in the information storage unit by the input unit. The second icon group includes icons of information moved to the first area on predetermined conditions, of icons contained in the second area. An amount of the second icon group moved to the first area can be modified by the input unit.

(2) The first area may include first and second openings and the modification may be made by modifying an amount of movement to the first area of icons contained in the second area in accordance with size of the first opening and modifying an amount of movement to the second area of icons contained in the first area in accordance with size of the second opening.

(3) Information of the second icon group reproduced by the information processing unit may be moved to the second area through the second opening.

(4) The information display unit may display the icons in the second area so that the icons are moved in the display unit.

(5) The icons in the second area may be moved to the first area or the icons in the first area may be moved to the second area by the input unit.

(6) The predetermined conditions may be defined as icons of information being moved to the first area at random or as icons of information being moved to the first area depending on attribute of the icons or can be designated by the input unit.

(7) The input unit may set movement speed or size of the icons.

According to the present invention, the user can mix contents groups selected arbitrarily by the user with other reproducible contents in any ratio and reproduce them. The user can confirm in advance what contents groups are mixed before the contents groups are mixed, so that contents that the user does not desire are prevented from being reproduced. Further, the same contents will no longer have to be reproduced repeatedly, so the user can be prevented from being tired of the contents.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating the concept of movement of icons from a second area to a first area according to the present invention;

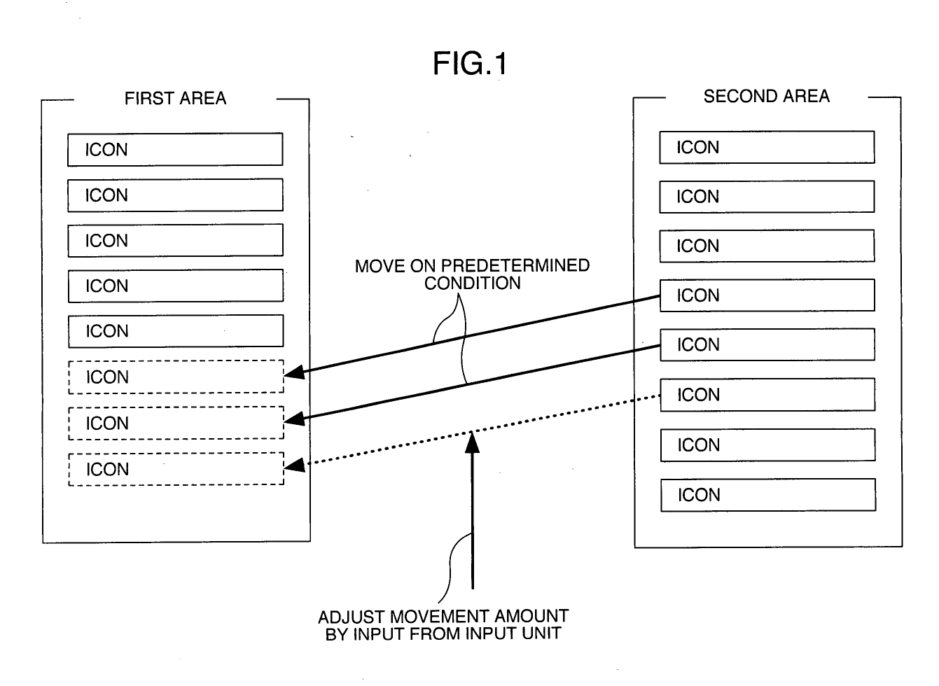

FIG. 2 is a schematic diagram illustrating an embodiment of the information reproduction apparatus according to the present invention;

FIG. 3 is a diagram showing library information of musical compositions used in the information reproduction apparatus of the embodiment in detail;

FIG. 4 is a schematic diagram illustrating a picture displayed in an information display unit used in the information reproduction apparatus according to the embodiment;

FIG. 5 is a flow chart showing processing operation starting from the starting operation of the information reproduction apparatus of the embodiment initiated by a program;

FIG. 6 is a flow chart showing processing operation for icons displayed in the information reproduction apparatus of the embodiment;

FIG. 7 is a diagram illustrating movement of icons within a second area defined in the information reproduction apparatus of the embodiment;

FIG. 8 is a diagram illustrating a method of designating conditions for icons displayed in the second area defined in the information reproduction apparatus of the embodiment;

FIG. 9 is a diagram illustrating the movement speed of icons changed in accordance with attributes thereof in the information reproduction apparatus of the embodiment;

FIG. 10 is a diagram illustrating the size of icons changed in accordance with attributes thereof in the information reproduction apparatus of the embodiment;

FIG. 11 is a diagram illustrating movement routes of icons changed in accordance with attributes thereof in the information reproduction apparatus of the embodiment;

FIG. 12 is a diagram illustrating movement of icons from the second area to the first area by means of an input unit used in the information reproduction apparatus of the embodiment;

FIG. 13 is a diagram illustrating movement of icons within the first area in the information reproduction apparatus of the embodiment;

FIG. 14 is a diagram illustrating reproduction of contents related to icons within the first area in the information reproduction apparatus of the embodiment;

FIG. 15 is a diagram illustrating an example of a picture displayed while contents are being reproduced in the information reproduction apparatus of the embodiment;

FIG. 16 is a diagram illustrating modification of order of icons within the first area in the information reproduction apparatus of the embodiment;

FIG. 17 is a diagram illustrating an opening controlled to be opened and closed in the information reproduction apparatus of the embodiment;

FIG. 18 is a diagram illustrating movement of icons within the second area into the first area through the opening in the information reproduction apparatus of the embodiment;

FIG. 19 is a diagram illustrating movement of icons within the first area into the second area through the opening in the information reproduction apparatus of the embodiment;

FIG. 20 is a diagram illustrating re-movement into the second area, of icons moved from the second area into the first area in the information reproduction apparatus of the embodiment;

FIG. 21 is a diagram illustrating an interface for retrieval in an information reproduction apparatus according to an embodiment 2 of the present invention;

FIG. 22 is a diagram illustrating an interface for retrieval (icons that do not coincide with conditions cannot enter area) in the information reproduction apparatus of the embodiment;

FIG. 23 is a diagram illustrating an interface for retrieval (even if icons coincide with conditions, the number of items enterable into area depends on the size of area) in the information reproduction apparatus of the embodiment;

FIG. 24 is a diagram illustrating an interface for retrieval (replacement of items coincident with conditions can be made arbitrarily by means of operation of the input unit) in the information reproduction apparatus of the embodiment;

FIG. 25 is a diagram illustrating an interface for retrieval (conditions can be combined and even items that cannot be retrieved by the combination can be confirmed) in the information reproduction apparatus of the embodiment;

FIG. 26 is a diagram illustrating narrowing-down operation in the opening by means of the interface for retrieval in the information reproduction apparatus of the embodiment;

FIG. 27 is a diagram illustrating movement of icons from the second area into the first area by means of the interface for retrieval in the information reproduction apparatus of the embodiment;

FIG. 28 is a diagram illustrating movement of icons from the second area into the first area when combination of interface for retrieval is used in the information reproduction apparatus of the embodiment;

FIG. 29 is a schematic diagram illustrating a configuration for reproducing musical composition data files existing in a remote place in an information reproduction apparatus according to an embodiment 3 of the present invention; and

FIG. 30 is a diagram showing restoration of icons in the first area utilizing a reproduction candidate list restoration table in an information reproduction apparatus according to an embodiment 4 of the present invention.

### DESCRIPTION OF THE EMBODIMENTS

Embodiments of the present invention are now described with reference to the accompanying drawings.

### Embodiment 1

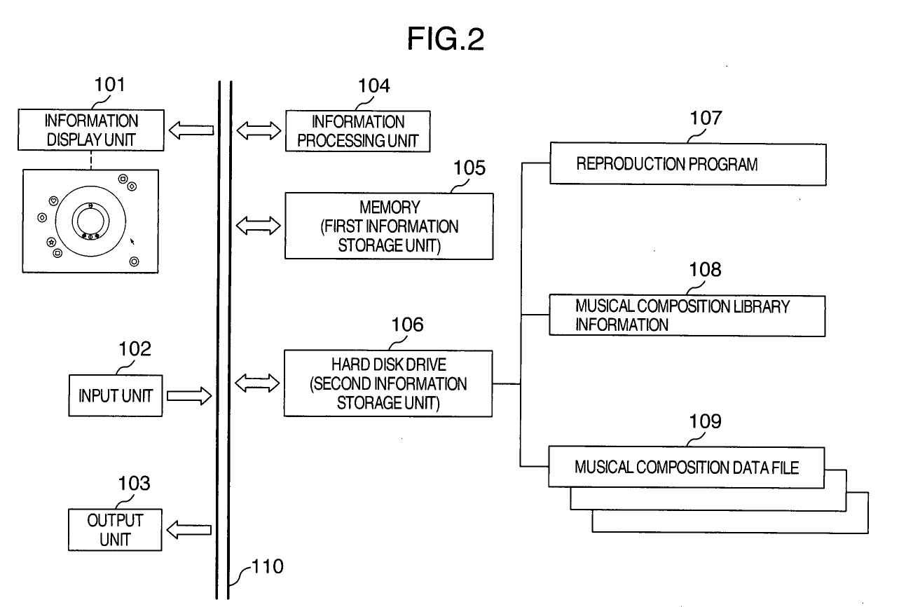

FIG. 2 is a schematic diagram illustrating an embodiment of an information reproduction apparatus according to the present invention. Numeral 101 denotes an information display unit (for example, display), 102 an input unit (for example, mouse, keyboard and remote controller), 103 an output unit (for example, loudspeaker, headphone and information display unit such as display), 104 an information processing unit (for example, central processing unit), 105 a first information storage unit (for example, memory) and 106 a second information storage unit (for example, hard disk drive). Information to be reproduced in the embodiment is music information as an example.

The information display unit 101, the input unit 102, the output unit 103, the information processing unit 104, the first and second information storage units 105 and 106 are connected to one another through a bus line 110.

The second information storage unit 106 stores a reproduction program 107, a musical composition library information 108 and a musical composition data file 109.

The information storage units are not only connected directly to the information processing unit but may be information storage units that exist in a remote place and can be connected to the information processing unit through a communication line such as the Internet.

The information reproduction program 107 describes the information processing procedure in the information reproduction apparatus of the present invention.

The musical composition data file is music information processed by the information processing unit 104 and outputted by the output unit 103 finally.

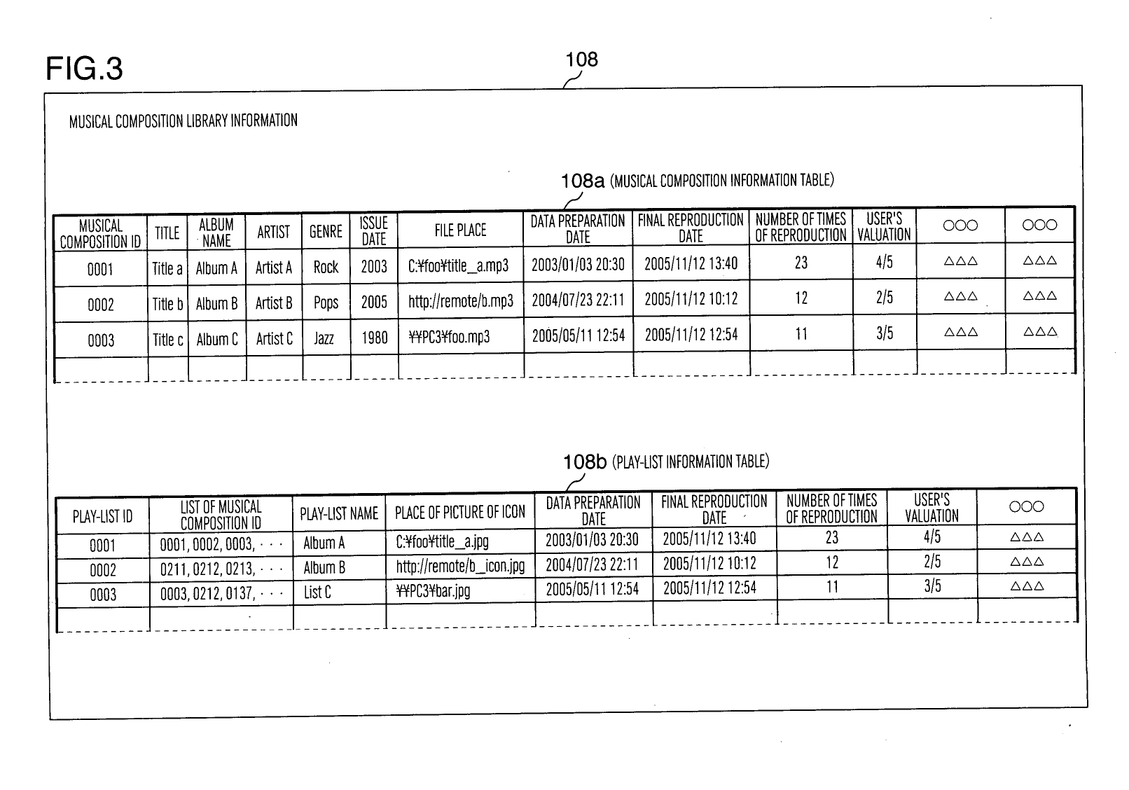

The musical composition library information includes, as shown in FIG. 3, a musical composition information table 108a in which attribute information attached to musical composition data files and user's looking and listening records and valuation and the like are arranged and a play-list information table 108b in which reproduction order of musical composition data files and information of places of picture files when they are displayed as icons and the like are arranged. Data in the play-list information table 108b contain 1 or 2 or more pieces of information for identifying data in the musical composition information table 108a and 1 or 2 or more pieces of data in the musical composition information table can be referred from data in the play-list information table 108b. Further, the referred data of the musical composition information table can be used to refer to the musical composition data file holding music information reproduced by the output unit.

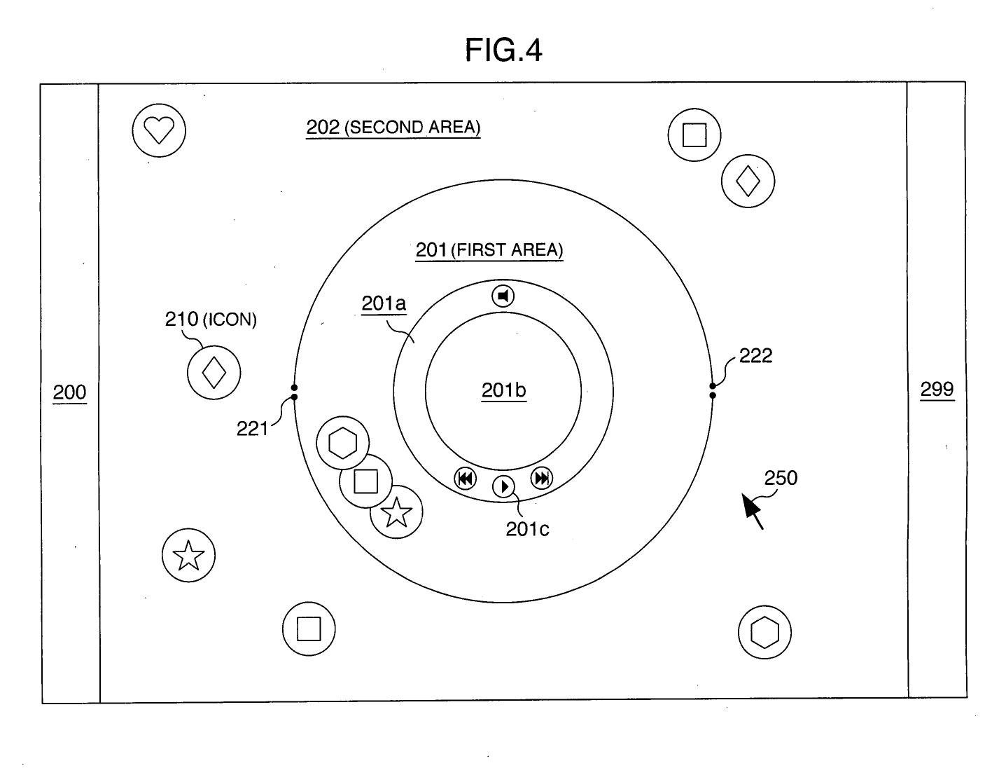

FIG. 4 shows an example schematically illustrating a picture displayed in the information display unit used in the information reproduction apparatus according to the embodiment. In FIG. 4, visualized pictures of data in the play-list information table are icons 210. Icons 210 of reproduction candidates exist in a first area 201 and icons 210 of added candidates to the first area 201 exist in a second area 202. An area 201b where an icon being reproduced currently is positioned is formed in the first area and buttons 201c for controlling reproduction and stop of musical composition, skip to next music and the like are disposed in the first area. Areas 200 and 299 are not displayed in the information display unit. Openings 221 and 222 can be opened and closed in accordance with the user's instructions from the input unit. Further, a cursor 250 is a visualized mouse constituting the input unit.

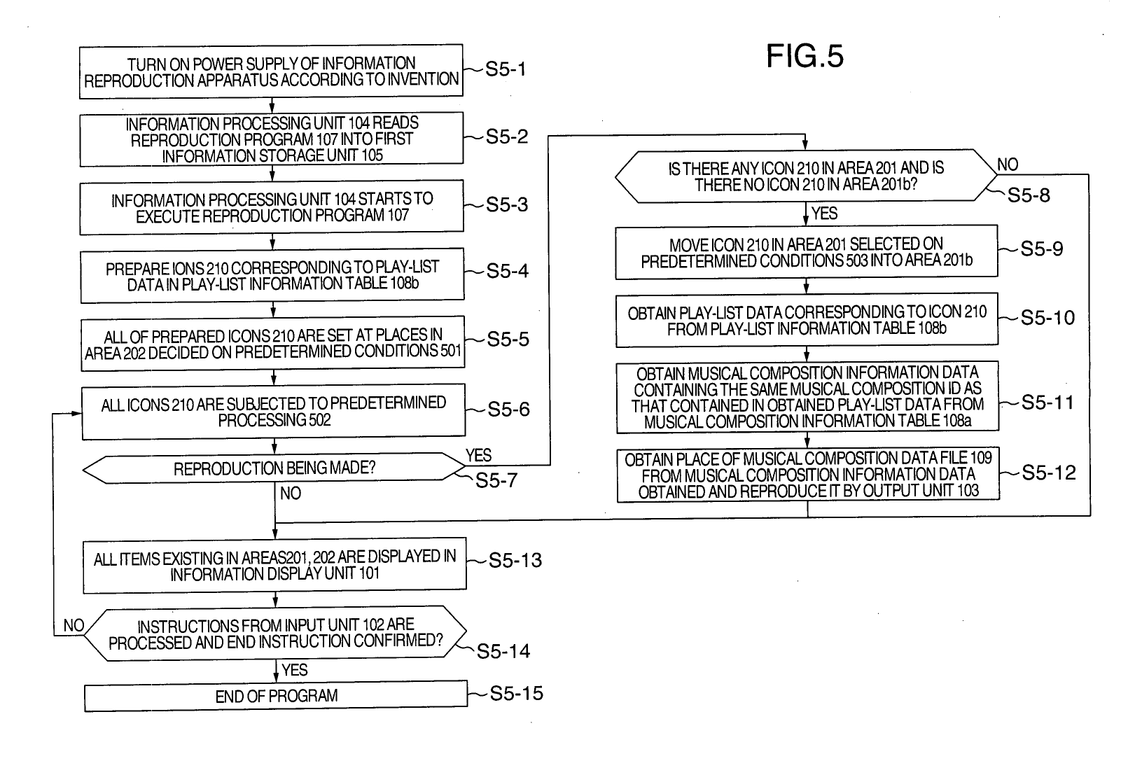

Referring now to FIG. 5, a flow of processing operation starting from turning on of power supply of the information reproduction apparatus according to the present invention is described. First, when the power supply of the information reproduction apparatus according to the present invention is turned on (step S5-1), the information processing unit 104 reads in the reproduction program 107 stored in the second information storage unit 106 to be stored in the first information storage unit 105 (step S5-2) and performs processing operation in accordance with the procedure described in the reproduction program 107 (step S5-3).

When execution of the reproduction program 107 is started, the information processing unit 104 reads in the play-list information table 108b from the second information storage unit 106 and prepares icons 210 corresponding to data (step S5-4).

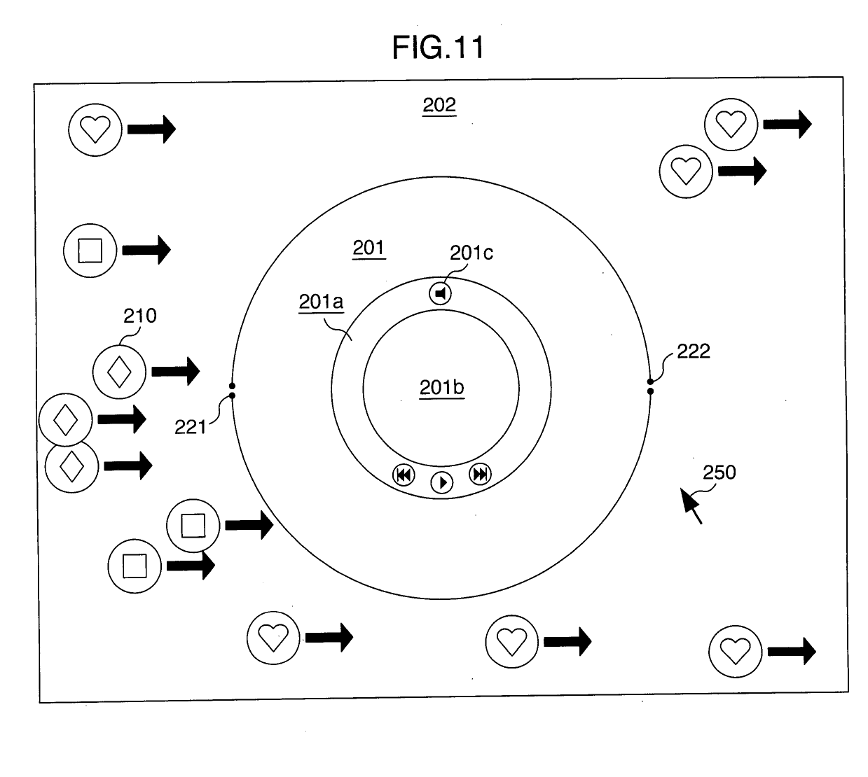

The prepared icons 210 are set or positioned at places in the second area 202 decided on predetermined conditions 501 (step S5-5). The predetermined conditions 501 can be defined as icons 210 being set or positioned at random or as positions of icons 210 being changed in accordance with attribute information (for example, user's valuation) in the play-list corresponding to icons 210 as shown in FIG. 11 or may be designated by the input unit.

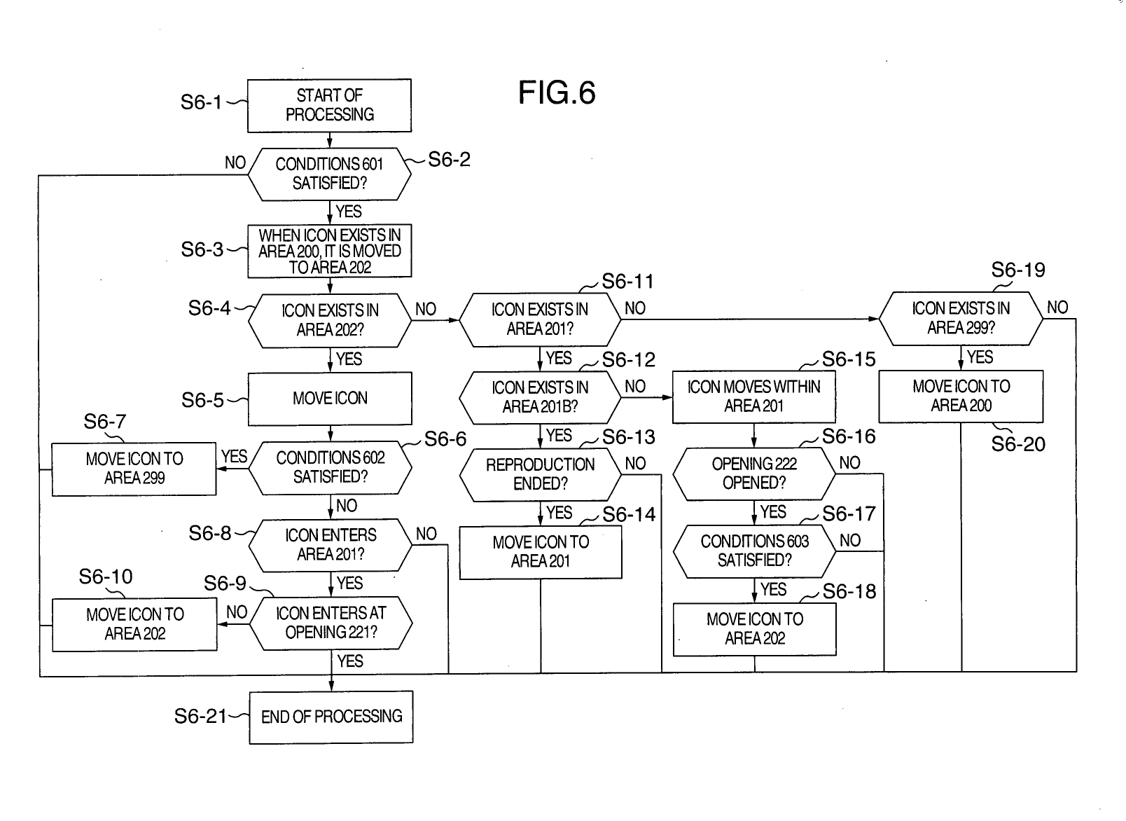

All of the icons 210 prepared above are subjected to predetermined processing 502 (step S5-6). The predetermined processing 502 for the icons 210 in step S5-6 is described as shown in FIG. 6 and will be described later in detail.

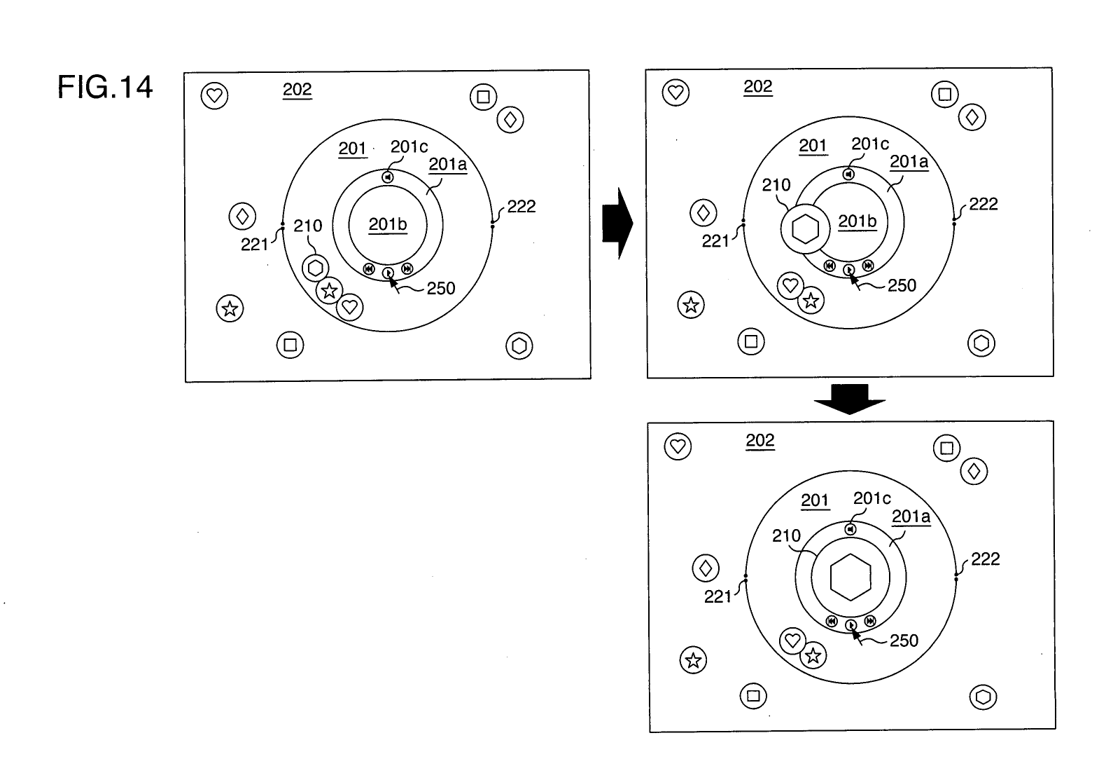

Thereafter, whether reproduction is being made or not (whether a stop instruction was issued or not after a reproduction start instruction was already issued by the input unit) is confirmed (step S5-7). When reproduction is being made, it is confirmed that there is any icon 210 in the first area 201 and there is no icon 210 in the area 201b (step S5-8). Icon 210 in the first area 201 selected on predetermined conditions 503 is moved into the area 201b (step S5-9) and the play-list data corresponding to the moved icon 210 is obtained from the play-list information table 108b (step S5-10). The musical composition information data contained in the obtained play-list data is obtained from the musical composition information table 108a (step S5-11) and the place of the musical composition data file 109 is obtained from the obtained musical composition information data. Information of the musical composition data file is reproduced by the information processing unit 104 and its output is produced by the output unit 103 (step S5-12). Movement of icon 210 in the first area 201 into the area 201b is made as shown in FIG. 14, for example.

The predetermined conditions 503 is defined as an icon 210 having earlier order of addition to the first area 201 among the icons 210 existing within the first area 201 and the number of times of reproduction being smallest since execution of the reproduction program 107 was started being selected by way of example. Further, an icon 210 existing within the first area 201 may be selected at random. When the icon 210 is selected at random, the selection may be weighted with the number of times of reproduction of the play-list corresponding to the icon 210 to be processed since utilization of the present apparatus was started or user's valuation.

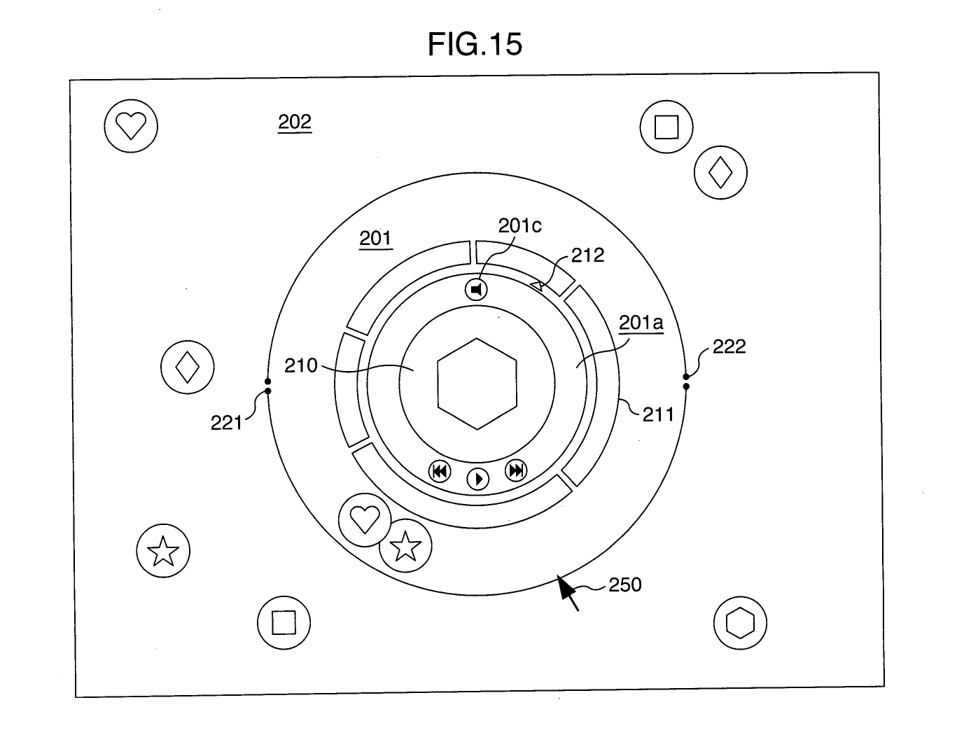

After the confirmation as to whether reproduction is being made (step S5-7), all items existing in the first and second areas 201 and 202 are displayed in the information display unit 101 irrespective of the processing in steps S5-8 to S5-12 (step S5-13). When icons 210 are displayed, the icons 210 can be displayed while the sizes of the icons 210 are varied in accordance with attribute information (for example, user's valuation) of the play-list corresponding to the icons 210. Further, when reproduction is being made, the number of musical compositions constituting the play-list, reproduction time 211 occupying the whole play-list or a point 212 where reproduction is being made currently may be displayed around the area 201b as shown in FIG. 15. In addition, an area like an area 201a may be formed to display a control icon (for example, icon 201c for controlling volume) therein.

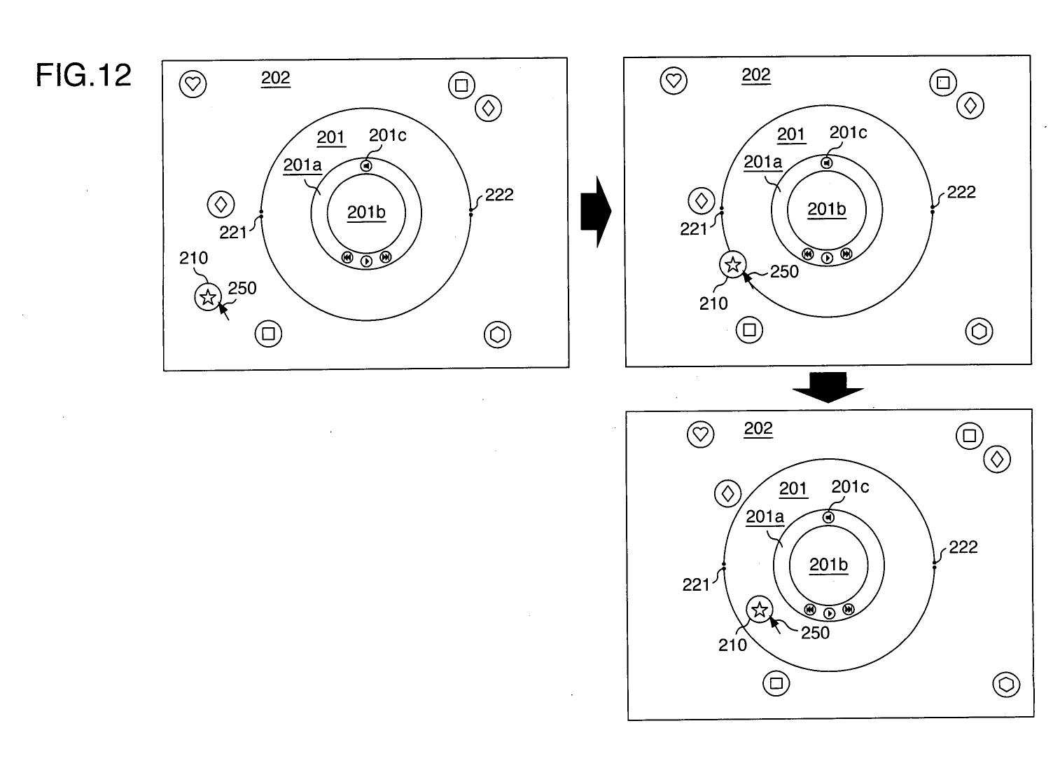

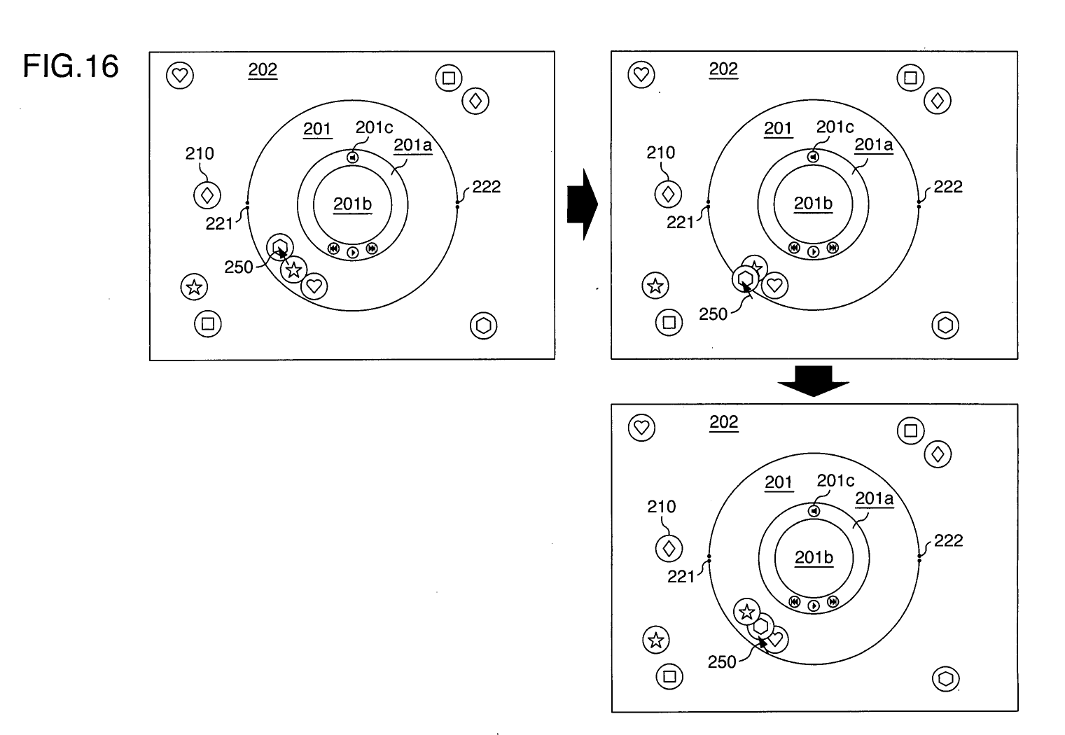

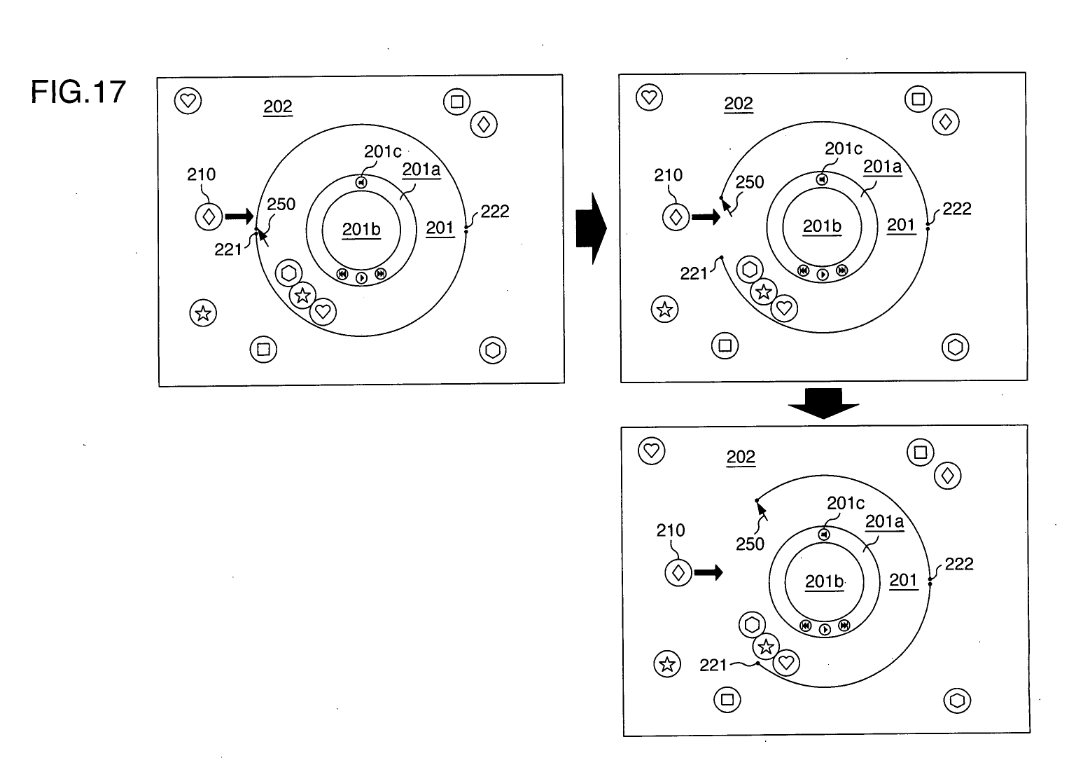

Thereafter, instructions inputted by the input unit 102 are processed and processing operation continuing from the predetermined processing for all the icons 210 is performed repeatedly until an end instruction of the reproduction program 107 is received from the input unit (step S5-14). When the end instruction of the reproduction program 107 is received, the reproduction program 107 is ended and the power supply of the information reproduction apparatus is turned off (step S5-15). The instructions from the input unit 102 contain reproduction instruction (FIG. 14), instruction of moving the icon 210 from the second area 202 to the first area 201 (FIG. 12) and instruction of opening and closing the opening 221 (FIG. 17) besides the end instruction. An instruction of re-arranging icons 210 in the first area 201 (FIG. 16) may be executed.

The predetermined processing 502 for the icon 210 in step S5-6 is performed as shown in FIG. 6.

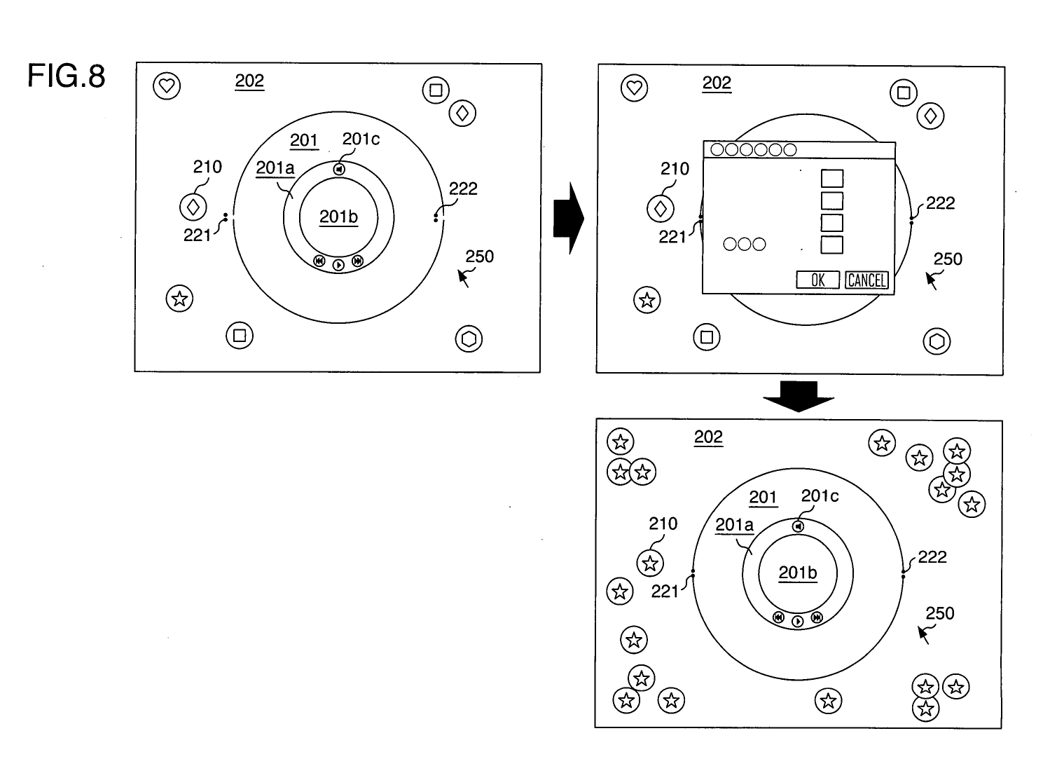

When the processing 502 for the icon 210 is started (step S6-1), conditions 601 are first confirmed (step S6-2). The conditions 602 are to confirm whether the icon 210 to be processed exists in the first area or the second area or whether the icon 210 to be processed can be moved to the second area or not. Whether the icon to be processed can be moved to the second area is defined on predetermined conditions 801. The predetermined conditions 801 contain, for example, designation of the maximum number of icons 210 that can exist in the second area and genre of the musical composition that can exist in the second area. The predetermined conditions 801 can be set by instructions inputted by the input unit 102 in the setting picture of FIG. 8.

When the conditions 601 are not satisfied, the processing 502 for the icon 210 to be processed is ended (step S6-21). When the conditions 601 are satisfied and the icon 210 to be processed exists in the area 200, the icon 210 to be processed is moved to the area 202 (step S6-3). After the step S6-3, it is confirmed whether the icon 210 to be processed exists in the area 202 or not (step S6-4).

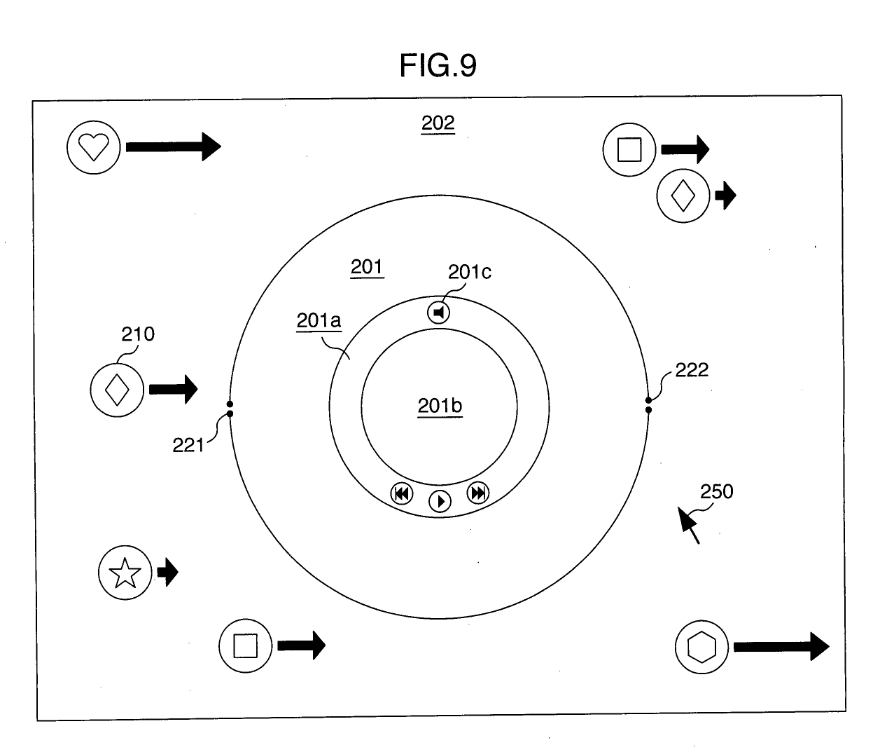

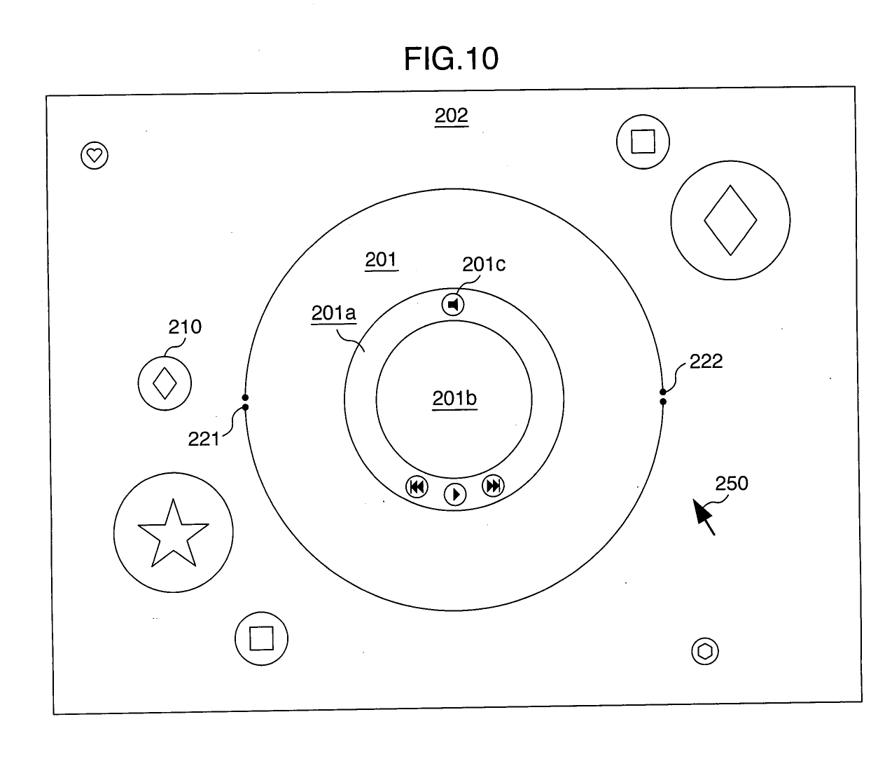

When the icon 210 exists in the area 202, the icon 210 is moved (step S6-5). As an example of the movement method, there is a method that the icon is moved from left to right in the second area. In this case, the speed of movement (FIG. 9) or the size of icon (FIG. 10) can be further changed in accordance with attribute information (for example, user's valuation) of the play-list corresponding to the icon 210 to be processed.

After the icon to be processed is moved, it is confirmed whether the conditions 602 are satisfied or not (step S6-6). When the conditions are satisfied, the icon to be processed is moved to the area 299 (step S6-7). The conditions 602 contain, for example, conditions as to whether the icon 210 is set or positioned at right position from the right end of the picture when the icon is moved from left to right in the second area 202 or whether the designated time elapses since the icon 210 was moved to the second area 202 or not.

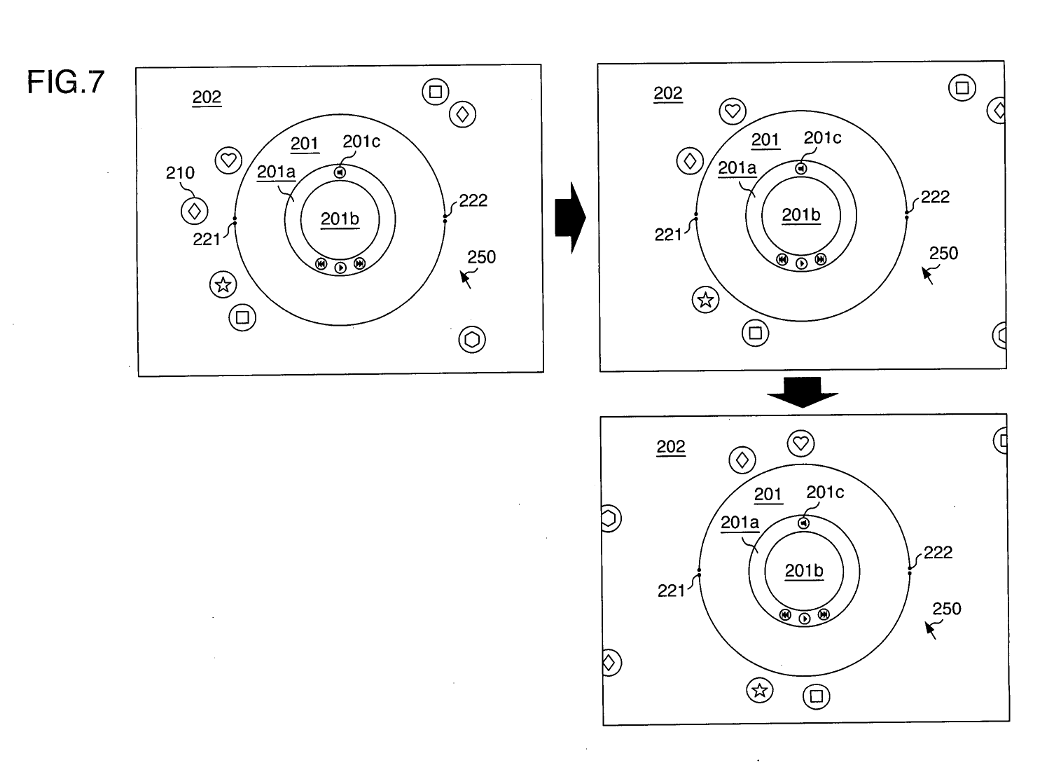

When the conditions 602 are not satisfied, it is confirmed whether the icon 210 to be processed enters the first area 201 or not (step S6-8). When the icon 210 to be processed does not enter the area 201, the processing for the icon 210 is ended (step S6-21). When the icon 210 to be processed enters the area 201, it is confirmed whether the icon 210 to be processed enters at the opening 221 or not (step S-9). When the icon 210 enters at the opening 221, the processing for the icon 210 is ended (step S6-21). When the icon to be processed does not enter at the opening 221, the icon 210 to be processed is moved to the second area 202 (step S6-10) and the processing is ended (step S6-21). Whether the icon enters at the opening 221 or not depends on what degree the opening 221 is opened. As shown in FIG. 7, when the opening 221 is not opened at all, the icon 210 cannot enter the first area 201 from the second area 202.

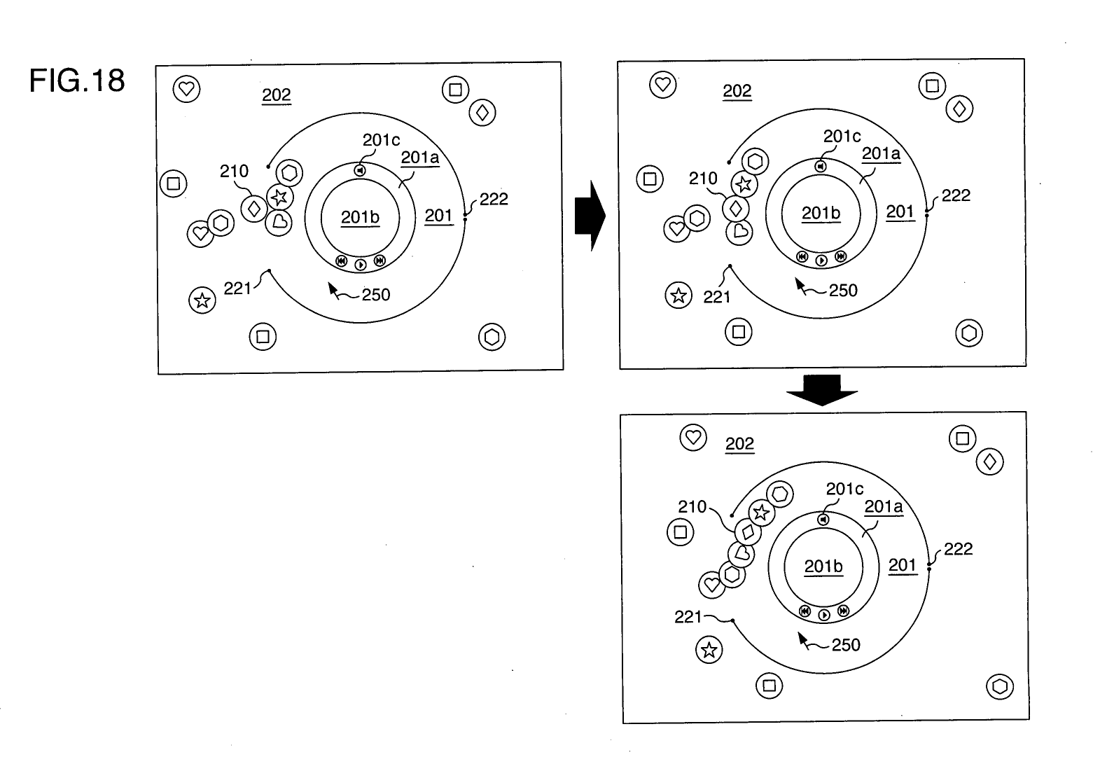

The openings 221 and 222 can be opened by instructions from the input unit as shown in FIG. 16 and the degree of opening can be also instructed. Accordingly, icons 210 moved from the first area to the second area by user's instructions from the input unit and other icons existing in the second area can be mixed in the ratio designated by the user. Further, since the icon 210 moved from the second area to the first area through the opening is visualized information, it can be confirmed before it added to icons selected actively by the user (FIG. 18). Accordingly, when movement from the second area to the first area of the icon 210 expressing musical composition that the user feels undesirable in the situation where the user is set is predicted from movement of the icon 210, the user can close the opening 221 to thereby prevent the undesirable musical composition from being reproduced. In other words, according to the present invention, the user can recognize in advance what kind of contents are added to the contents to be reproduced and accordingly the contents added to the contents to be reproduced can be controlled in advance on the basis of the recognition.

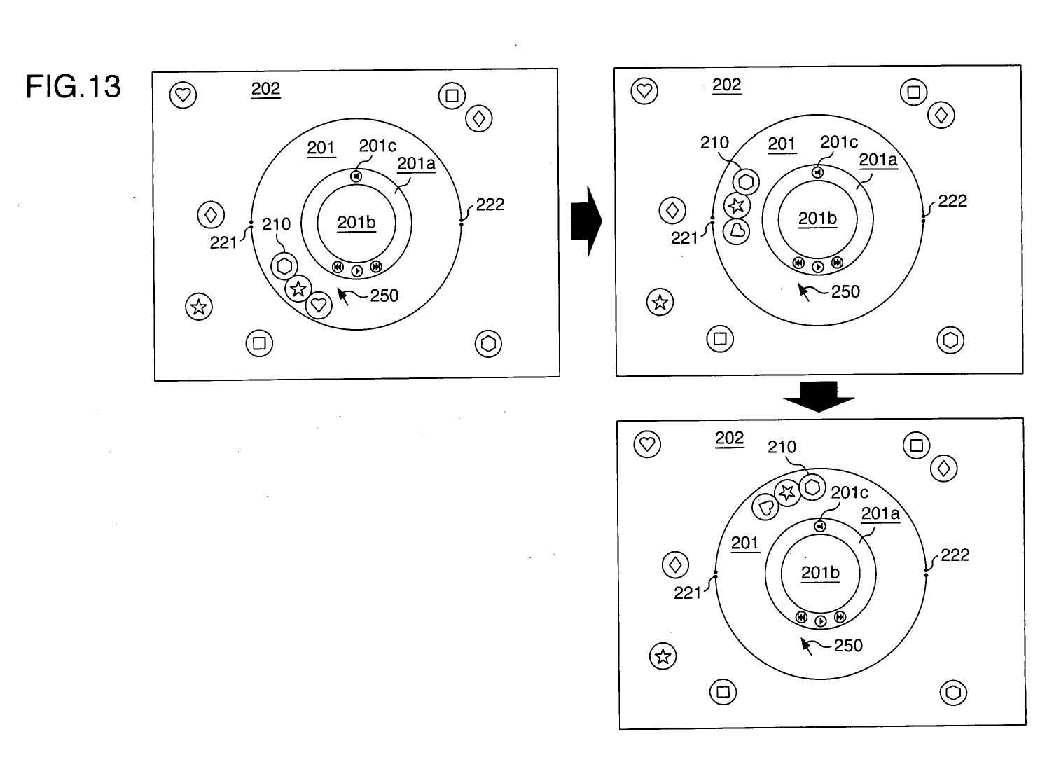

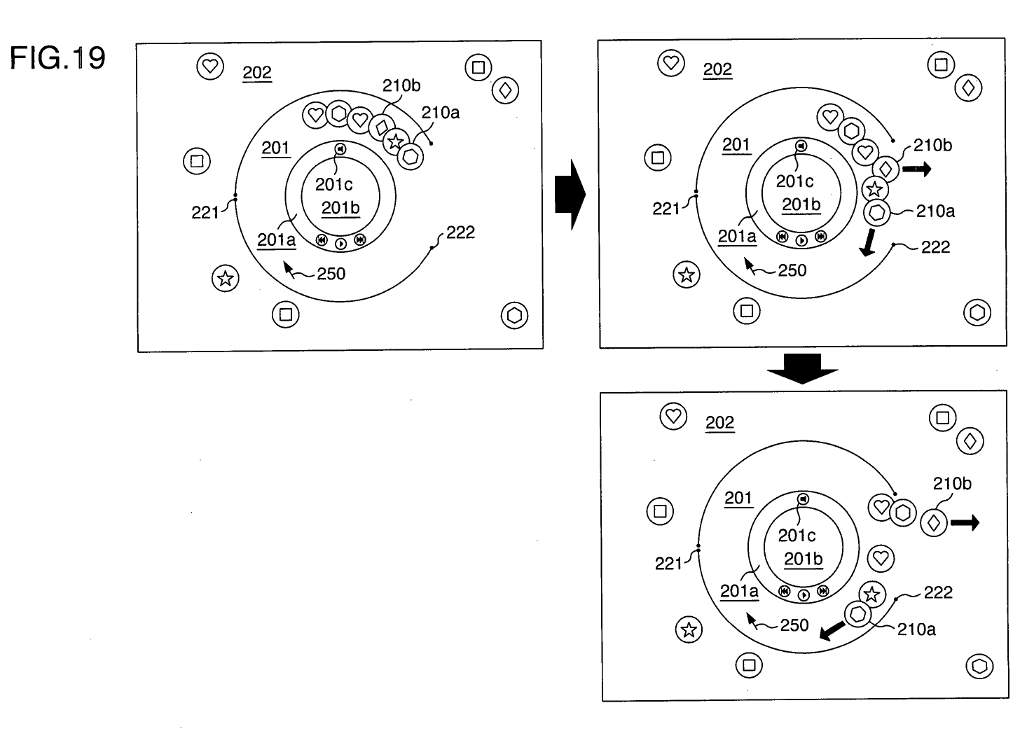

When no icon 210 to be processed exists in the area 202 in step the S6-4, it is confirmed whether the icon 210 to be processed exists in the area 201 or not (step S6-11). When the icon 210 to be processed exists in the area 201, it is first confirmed whether the icon to be processed exists in the area 201b or not (step S6-12). When the icon exists in the area 201b, it is confirmed whether reproduction of the final musical composition among the musical compositions related to the icon 210 to be processed is ended or not (step S6-13). When reproduction is not ended, the processing is ended (step S6-21). When reproduction is ended, the icon 210 to be processed is moved to the first area 201 (step S6-14) and the processing is ended (step S6-21). When the icon 210 to be processed does not exist in the area 201b, the icon moves within the area 201 (step S6-15). In movement of the icon within the area 201, for example, the icon may be moved clockwise so that the icon is circulated within the area 201 as shown in FIG. 13. After movement of the icon within the area 201, it is confirmed whether the opening 222 is opened or not (step S6-16). When the opening 222 is not opened, the processing is ended (step S6-21). When the opening 222 is opened, it is confirmed whether conditions 603 are satisfied or not (step S6-17). When the conditions 603 are satisfied, the icon 210 to be processed is moved to the second area 202 (step S6-18) and the processing is ended (step S6-21). When the conditions 603 are not satisfied, the processing is ended (step S6-21). The conditions 603 contain, for example, conditions that the icon 210 moved from the second area 202 to the first area 201 without dependence on user's operation from the input unit exists near the opening 222. The conditions 603 can contain conditions as to whether reproduction is made by the designated number of times after the icon is moved to the first area. By opening the opening 222 if such conditions are set, the icon 210 entering the first area 201 from the second area 202 independent of user's intention can be moved to the second area automatically while icon 210 selected actively by the user is left in the first area 201 (FIG. 19).

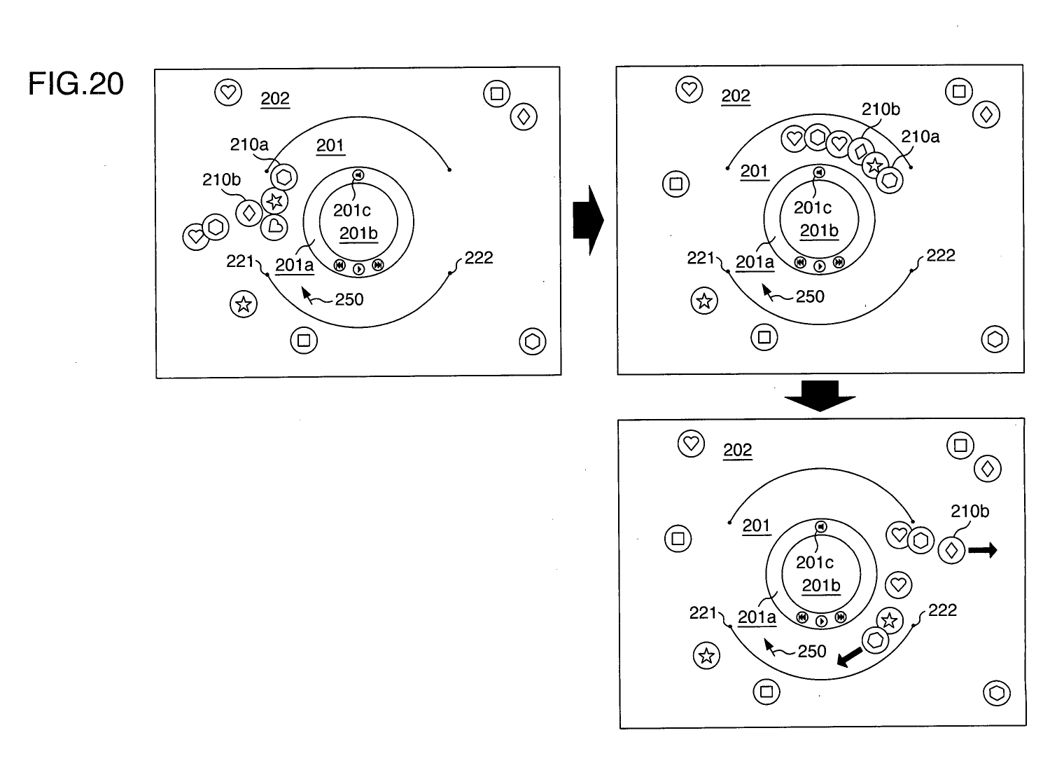

Further, the size of the openings 221 and 222 can be adjusted to thereby combine the icon 210 selected actively by the user with the icon 210 replaced automatically in any ratio, so that it can be prevented to fall into the state of “getting tired of listening”. A display example of the information display unit 101 in this case is as shown in FIG. 20.

In the step S6-11, when the icon 210 to be processed does not exist in the area 201, it is confirmed whether the icon exists in the area 299 or not (step S6-19). When the icon 210 to be processed does not exist even in the area 299, the processing is ended (step S6-21). When the icon 210 to be processed exists in the area 299, the icon to be processed is moved to the area 200 (step S6-20) and the processing is ended (step S6-21).

### Embodiment 2

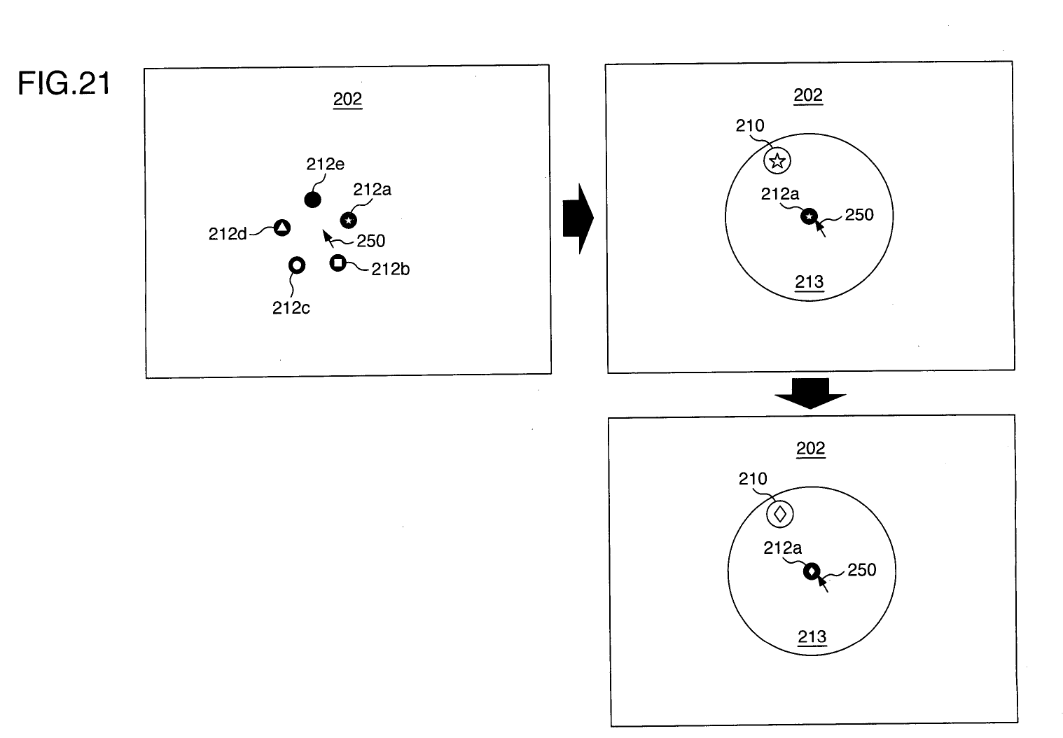

FIG. 21 illustrates an example of a retrieval interface in the information reproduction apparatus according to the present invention. Retrieval icons 212 can be displayed by instructions from the input unit 102. 1 or 2 or more retrieval icons 212 can be displayed. The retrieval icons 212 each correspond to retrieval conditions. For example, “genre is rock”, “genre is jazz”, “the number of times of reproduction is three times or more” and “the date of issue is 2005”. When one of the retrieval icons 212 displayed is selected by instructions from the input unit 102, 0 or 1 or more icons 210 coincident with the retrieval condition corresponding to the selected retrieval icon 212 are displayed in an influence range 213. The retrieval condition corresponding to the retrieval icon 212 can be changed by instructions from the input unit. The icon 210 coincident with the corresponding retrieval condition can be changed in response to the change of the retrieval condition, so that the icons are replaced dynamically and change of the result caused by the change of the retrieval condition can be confirmed dynamically to thereby be apt to set the retrieval condition for getting the result desired by the user. For example, the difference between plural conditions of, for example, “the number of times of reproduction is 6 or more times” and “the number of times of reproduction is 5 or more times” can be confirmed dynamically.

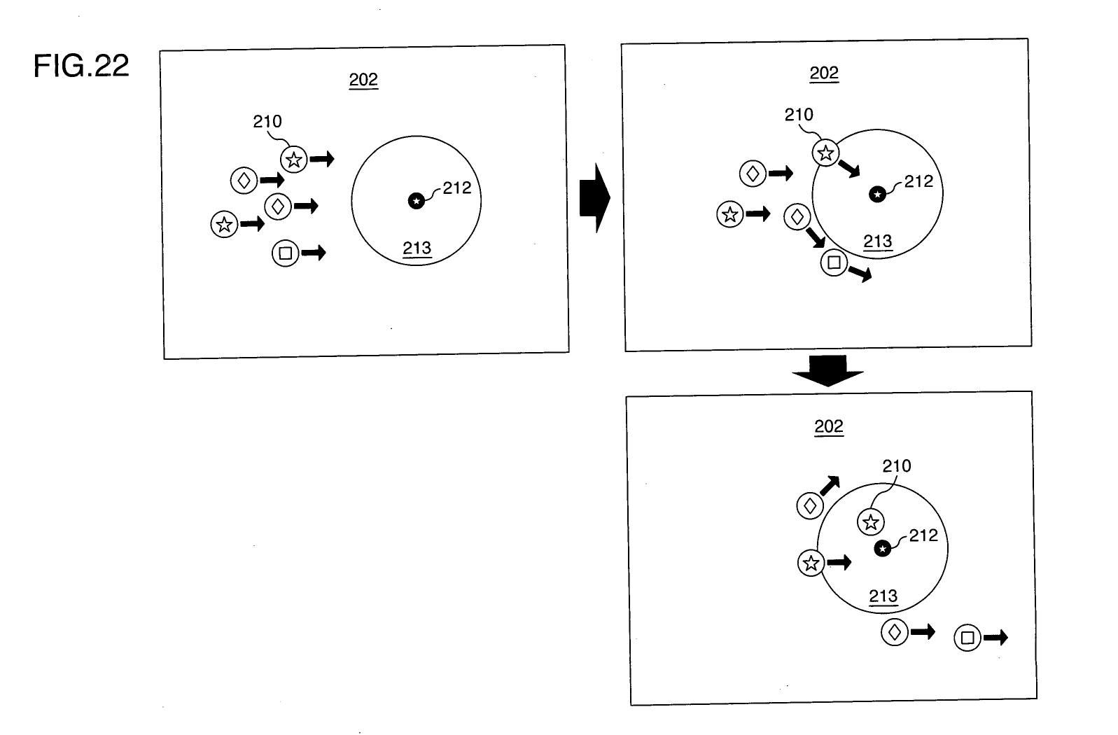

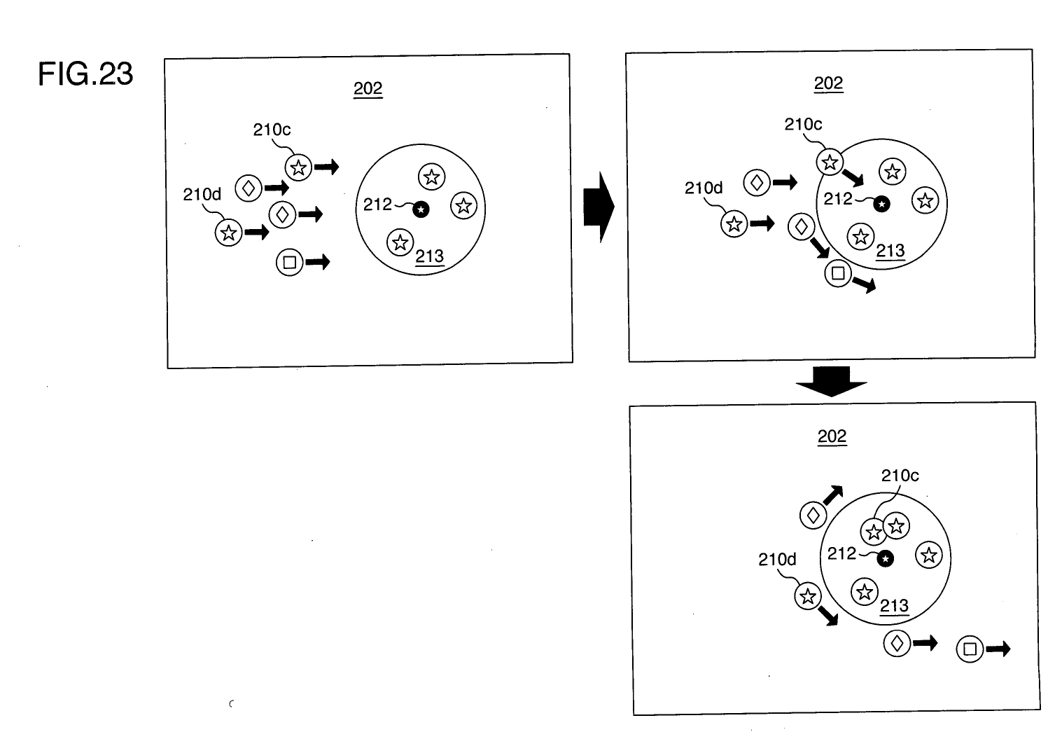

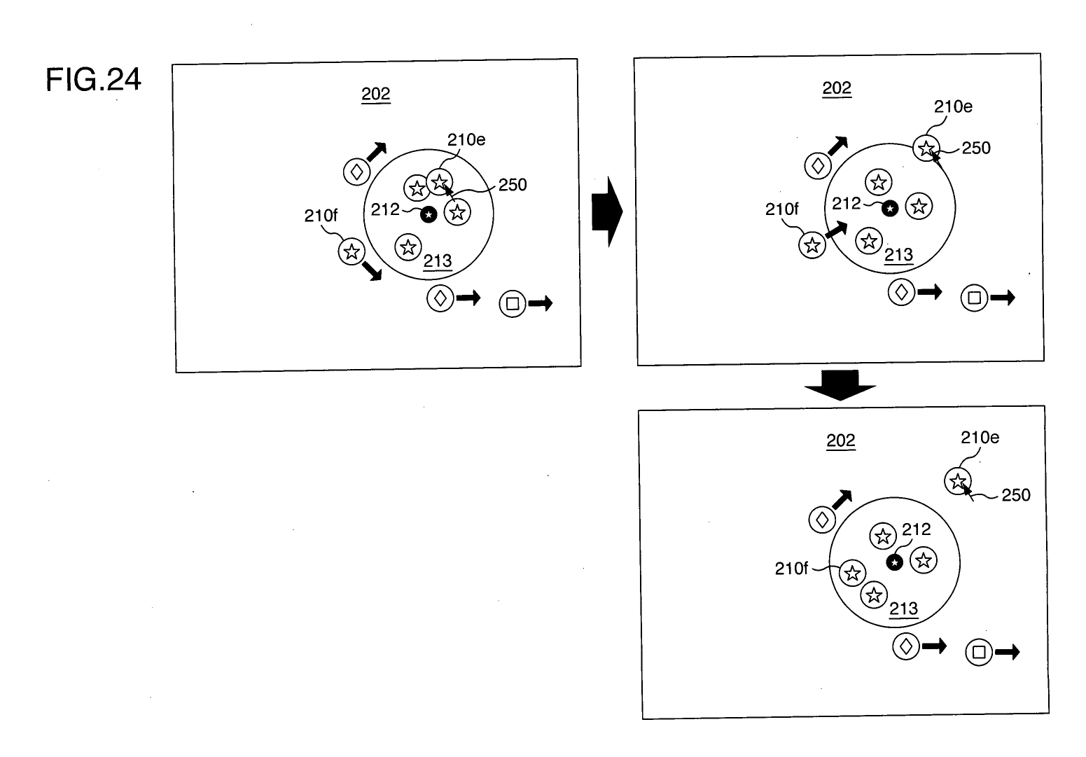

FIGS. 22 and 23 show states in case where the retrieval icon 212 is set on the locus of the moving icons 210. Since only icons 210 coincident with the retrieval condition corresponding to the retrieval icon 212 remain in the influence range 213 of the retrieval icon 212, icons 210 coincident with the retrieval condition can be collected. However, the number of icons 210 that can remain in the influence range 213 of the retrieval icon 212 is limited as shown in FIG. 23. For example, icons 210c that are smaller than or equal in number to the limitation number can remain in the influence range 213 of the retrieval icon 212, although icons 210d cannot remain therein since the limitation number is reached by the icons 210c. However, icon 210e unnecessary for the user can be removed from the influence range 213 of the retrieval icon 212 by instructions from the input unit 102 as shown in FIG. 24, so that icon 210f that could not remain in the influence range 213 of the retrieval icon 212 can remain therein. The number of icons 210 that can remain in the influence range 213 of the retrieval icon 212 depends on the size of the influence range 213 and the boundary between the influence range 213 and the area 202 can be modified by instructions from the input unit 102 to thereby adjust the size of the influence range.

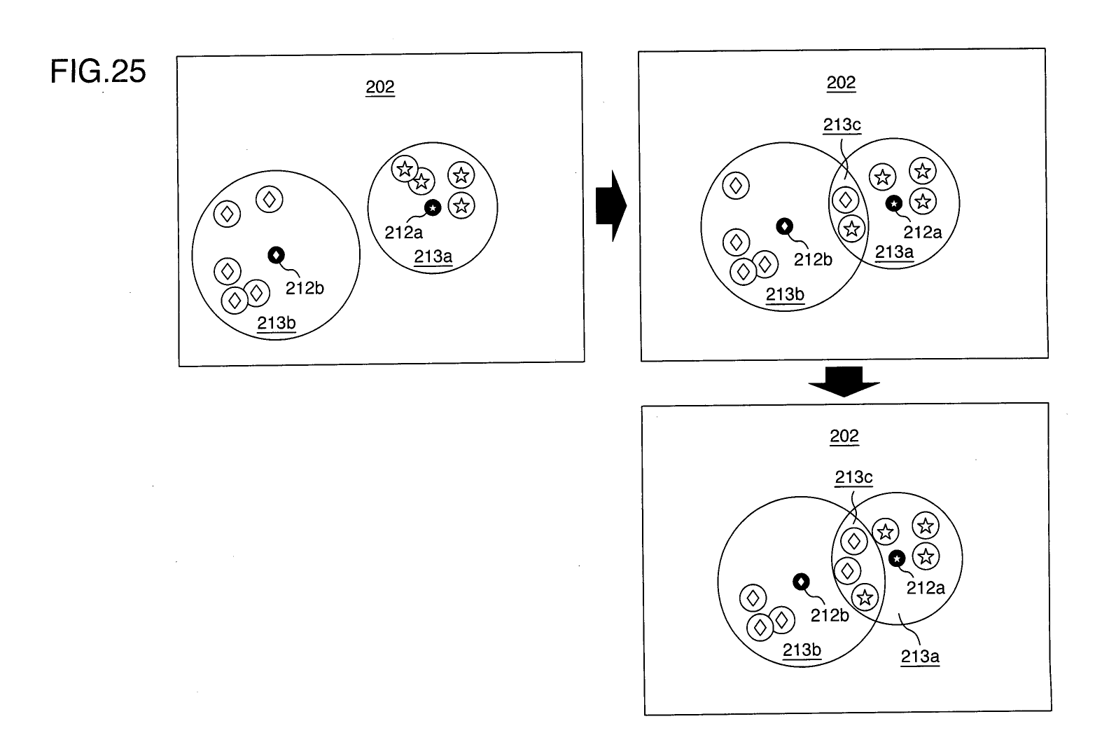

Further, as shown in FIG. 25, a plurality of retrieval icons 212 can be produced, so that retrieval can be made in parallel and the respective influence ranges 213 of the plurality of retrieval icons 212 can be overlapped one another in the information display unit 101 to thereby perform AND retrieval. The number of icons 210 collected by AND retrieval depends on the size of the overlapped area of the influence ranges 213.

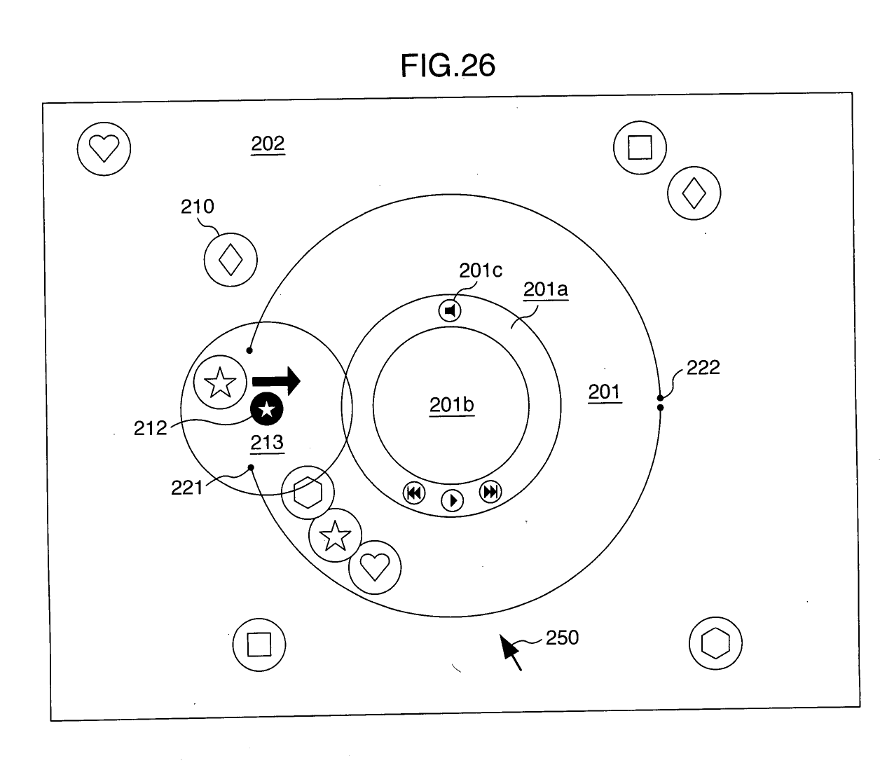

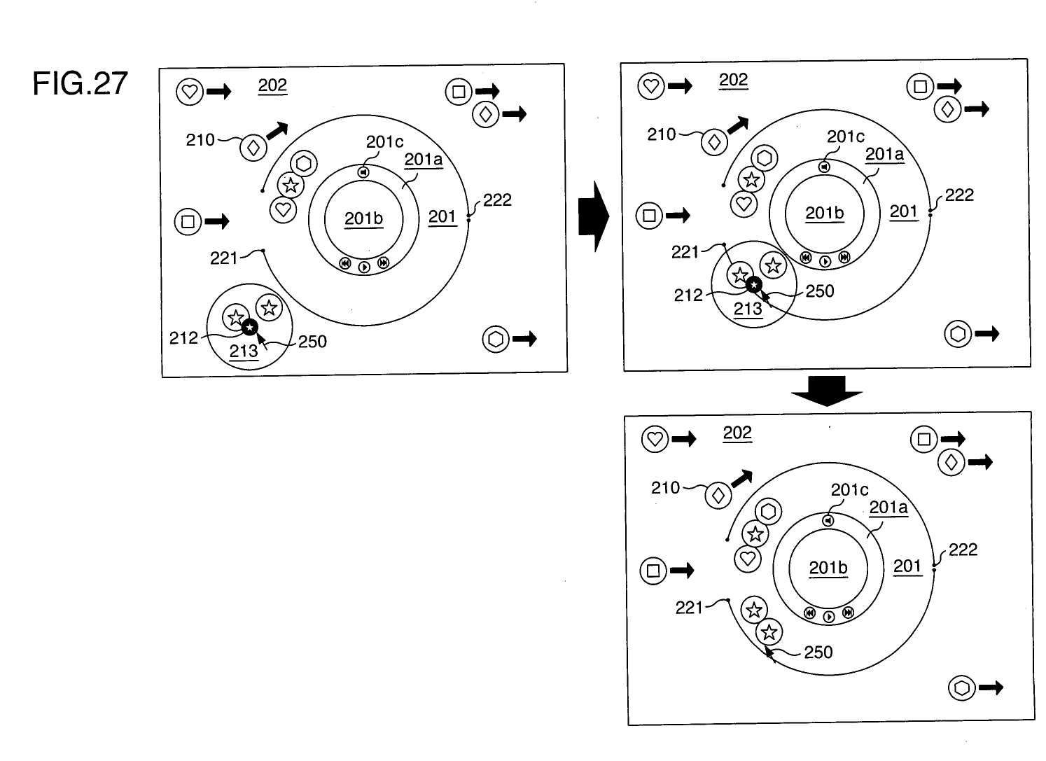

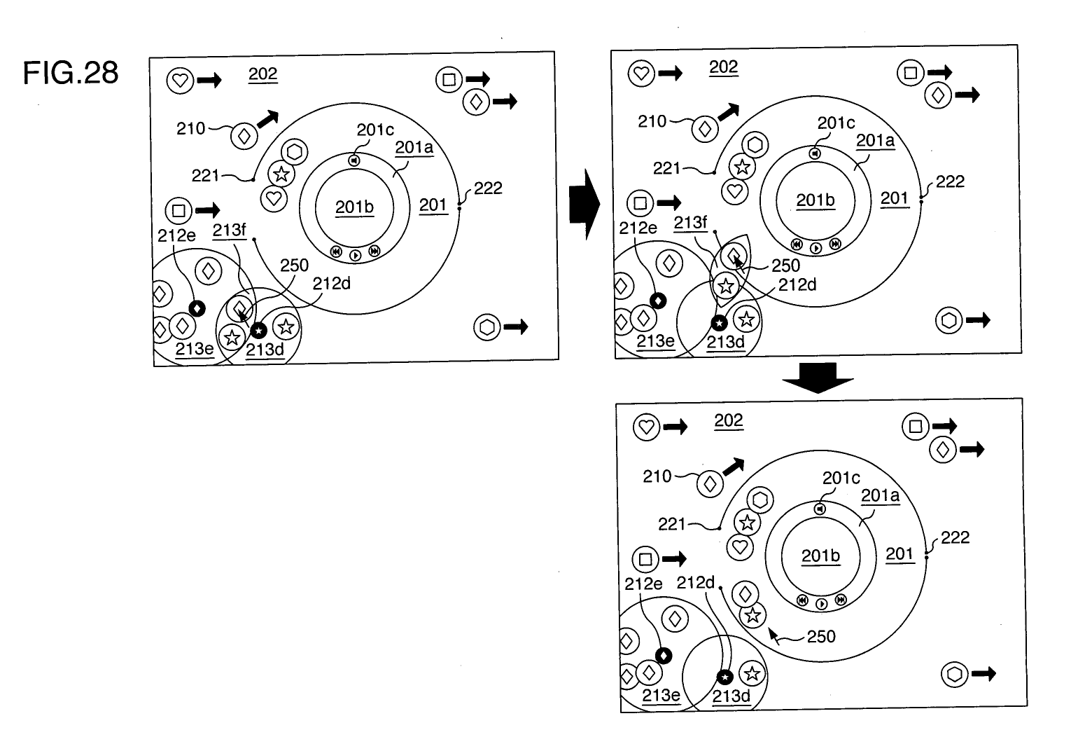

When the retrieval icon 212 is combined with the embodiment 1, the icons 210 moved to the first area can be limited as shown in FIG. 26. Further, as shown in FIGS. 27 and 28, a group of icons 210 coincident with the retrieval condition can be moved to the first area at a time.

### Embodiment 3

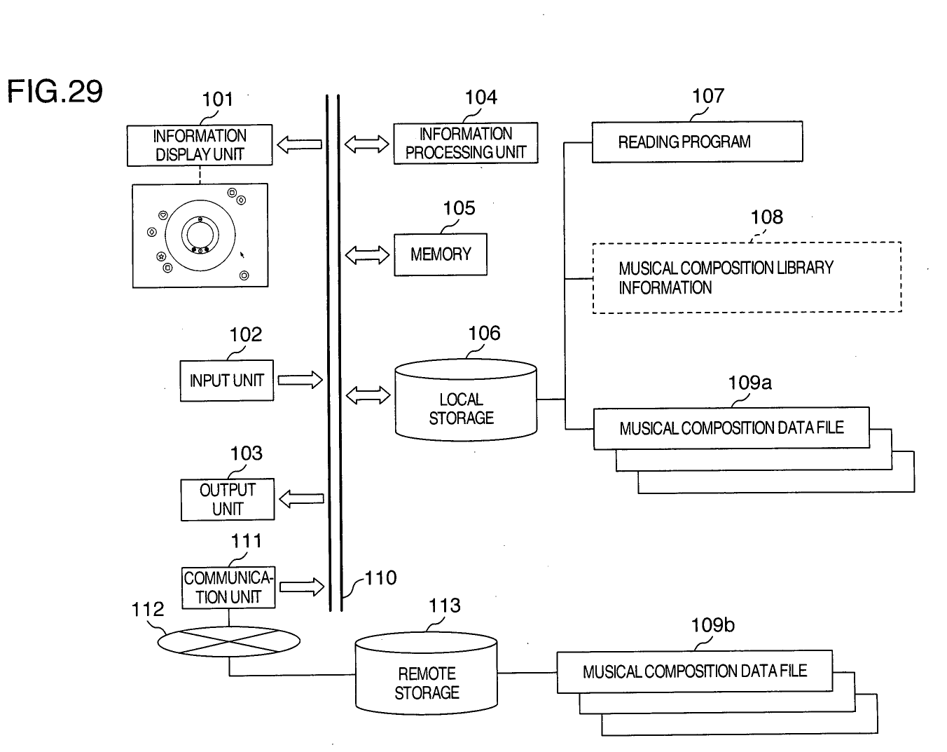

FIG. 29 schematically illustrates a configuration for reproducing musical composition data files 109b stored in a remote storage 113 connected to a network 112. Numeral 111 denotes a communication unit that is connected to the bus line 110. Data of musical composition file 109b is transmitted to the bus line 110 through the network 112 by means of the communication unit 111 to be processed by the information processing unit 104 and be reproduced. As described above, even information in a remote place can be reproduced through the network 112.

### Embodiment 4

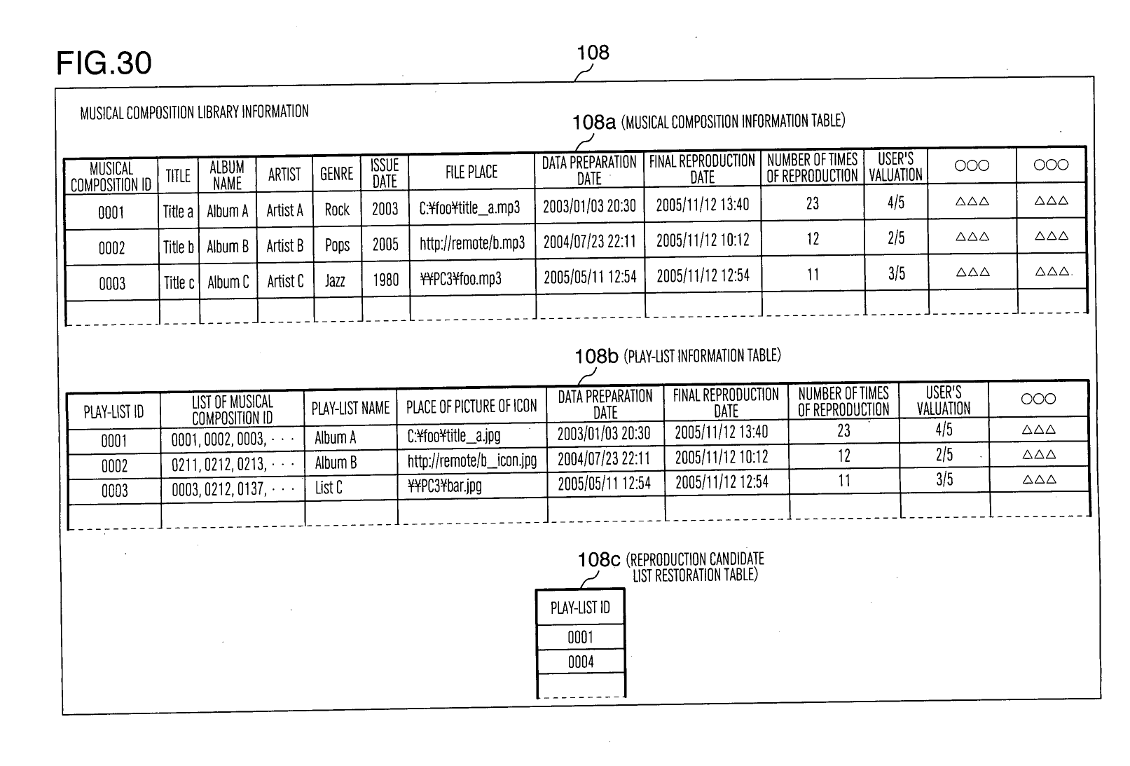

FIG. 30 shows the musical composition library information 108 in which a reproduction candidate list restoration table 108c is stored or registered in addition to the musical composition information table 108a and the play-list information table 108b. In processing between steps S5-5 and S5-6 of the reproduction program 107, a play-list having the same ID as the play-list ID stored in the reproduction candidate list restoration table 108c is obtained from the play-list information table 108b and a position of the icon 210 corresponding to data of the obtained play-list is set in the area 201. Further, when the reproduction program 107 is ended, data in the reproduction candidate list restoration table are updated by the play-list IDs of the icons 210 existing in the area 201. The data stored in the reproduction candidate list restoration table 108c may include positional information of icons 210, reproduction order and the like in addition to the play-list ID. In the above processing, the state of the icons existing in the first area at the time that the information reproduction apparatus according to the present invention is ended can be restored.

### Embodiment 5

An information reproduction apparatus according to an embodiment 5 of the present invention can be applied to a recommendation system of information contents in which icons 210 of information contents possessed by the user are displayed in the first area 201 and information contents that are not possessed by the user, for example, icons 210 relative to the icons existing in the first area among information contents purchasable in a store or Web site in which the information reproduction apparatus according to the present invention is installed are displayed in the second area 202.

### Embodiment 6

An information reproduction apparatus according to an embodiment 6 of the present invention can be realized by installing an information reproduction program of the present invention in a conventional information reproduction apparatus and executing information processing of the present invention.

The information reproduction apparatus according to the present invention can be utilized as a reproduction apparatus of music and picture contents and a semi-automatic reading apparatus of Web utilizing an information apparatus such as a personal computer (PC), a hard disk drive (HDD) recorder, an on-vehicle information terminal and a portable information terminal.

It should be further understood by those skilled in the art that although the foregoing description has been made on embodiments of the invention, the invention is not limited thereto and various changes and modifications may be made without departing from the spirit of the invention and the scope of the appended claims.

1. An information reproduction apparatus comprising:
an information storage unit for storing information;
an information display unit for displaying information;
an input unit for inputting instructions from outside;
an information processing unit for processing information; and
an output unit for outputting information reproduced by the information processing unit; wherein
the information display unit having first and second areas and displaying information stored in the information storage unit as icon,
the information processing unit reproducing information of the icons contained in the first area,
the icons contained in the first area including a first icon group having 1 or 2 or more icons and a second icon group having 1 or 2 or more icons;
the first icon group including icons of information selected from information stored in the information storage unit by the input unit,
the second icon group including icons of information moved to the first area on predetermined conditions, of icons contained in the second area,
an amount of the second icon group moved to the first area being cable of being modified by the input unit.

2. An information reproduction apparatus according to claim 1, wherein
the first area includes first and second openings; and
the modification is made by modifying an amount of movement to the first area of icons contained in the second area in accordance with size of the first opening and
modifying an amount of movement to the second area of icons contained in the first area in accordance with size of the second opening.

3. An information reproduction apparatus according to claim 2, wherein
information of the second icon group reproduced by the information processing unit is moved to the second area through the second opening.

4. An information reproduction apparatus according to claim 1, wherein
the information display unit displays the icons in the second area so that the icons are moved in the display unit.

5. An information reproduction apparatus according to claim 1, wherein
the icons in the second area are configured to be moved to the first area or the icons in the first area are configured to be moved to the second area by the input unit.

6. An information reproduction apparatus according to claim 1, wherein
the predetermined conditions are configured to be defined as icons of information being moved to the first area at random or as icons of information being moved to the first area depending on attribute of the icons or can be designated by the input unit.

7. An information reproduction apparatus according to claim 4, wherein
the input unit is configured to set movement speed or size of the icons.

8. An information reproduction apparatus according to claim 1, wherein
the input unit is configured to set maximum number or attribute of the icons capable of being displayed in the second area.

9. An information reproduction program for making an information reproduction apparatus including an information storage unit for storing information, an information display unit for displaying information, an input unit for inputting instructions from outside, an information processing unit for processing information and an output unit for outputting information reproduced by the information processing unit
function so that
the information display unit has first and second areas and displays information stored in the information storage unit as icons;
the information processing unit reproduces information of the icons contained in the first area;
the icons contained in the first area including a first icon group having 1 or 2 or more icons and a second icon group having 1 or 2 or more icons;
the first icon group including icons of information selected from information stored in the information storage unit by the input unit;
the second icon group including icons of information moved to the first area on predetermined conditions, of icons contained in the second area; and
an amount of the second icon group moved to the first area being cable of being modified by the input unit.

10. An information reproduction program according to claim 9, wherein
the first area includes first and second openings; and
the modification is made by modifying an amount of movement to the first area of icons contained in the second area in accordance with size of the first opening and
modifying an amount of movement to the second area of icons contained in the first area in accordance with size of the second opening.

11. An information reproduction program according to claim 10, wherein
information of the second icon group reproduced by the information processing unit is moved to the second area through the second opening.

12. An information reproduction production according to claim 9, wherein
the information display unit displays the icons in the second area so that the icons are moved in the display unit.

13. An information reproduction program according to claim 9, wherein
the icons in the second area are configured to be moved to the first area or the icons in the first area are configured to be moved to the second area by the input unit.

14. An information reproduction program according to claim 9, wherein
the predetermined conditions are configured to be defined as icons of information being moved to the first area at random or as icons of information being moved to the first area depending on attribute of the icons or can be designated by the input unit.

15. An information reproduction program according to claim 9, wherein
the input unit is configured to set movement speed or size of the icons.

16. An information reproduction program according to claim 9, wherein
the input unit can set maximum number or attribute of the icons capable of being displayed in the second area.
